(19) United States
(12) Patent Application Publication
(10) Pub. No.: US 2021/0319791 A1
(43) Pub. Date: Oct. 14, 2021

(54) ELECTRONIC APPARATUS AND CONTROLLING METHOD THEREOF

(71) Applicant: Samsung Electronics Co., Ltd., Suwon-si, Gyeonggi-do (KR)

(72) Inventors: Chihyun CHO, Suwon-si (KR); Beomseok OH, Suwon-si (KR); Jaewook JUNG, Suwon-si (KR)

(21) Appl. No.: 17/266,768

(22) PCT Filed: Mar. 21, 2019
(86) PCT No.: PCT/KR2019/003311

§ 371 Date: Feb. 8, 2021

(30) Foreign Application Priority Data
Nov. 27, 2018 (KR) 10-2018-0148233

(51) Int. Cl. G10L 15/22; H04L 29/08

(52) U.S. Cl. CPC G10L 15/22; G10L 2015/223; H04L 67/125

(57) ABSTRACT

A method for controlling another electronic apparatus in an electronic apparatus is provided. The method includes receiving a voice, identifying a control command corresponding to the received voice, identifying at least one type of sensing data related to the identified control command, requesting sensing data from a sensing apparatus corresponding to the at least one type of sensing data which is identified, and controlling at least one other electronic apparatus related to the identified control command based on sensing data received in response to the request.

### TECHNICAL FIELD

The disclosure relates to an electronic apparatus and a controlling method thereof, and more specifically, to an electronic apparatus that selectively collects sensing data from sensing apparatuses and controls another electronic apparatus based on the collected sensing data, and a method for controlling the other electronic apparatus in the electronic apparatus.

### BACKGROUND ART

With the development of computer technology, communication technology, and home electronics technology, the services with which the devices in the household and factory are connected by network and managed has been introduced, and this service is attracting attention as a future-oriented technology.

Especially, a research on the technology that a communication function is embedded in an object and the object is connected to the Internet, that is, Internet of Things (IoT) technology, has been accelerated.

The function of a sensor in the smart system realized as an IoT has been very important. An existing sensor has merely performed detection, but in the smart system, the sensor has been able to transmit sensing data to a processor, and the processor may make a decision for a user convenience based on the sensing data received from various sensors. For example, a smart home in which brightness of a lighting is automatically changed based on the illuminance detected by the illumination sensor has been capable of being realized.

As services required in the smart system become various, the type of the sensor has been increased and the number of sensors added to the smart system has been increased. According thereto, the amount of sensing data received by the processor has become enormous and there has been a problem that network/system resources are wasted due to continuous reception of sensing data even though the sensing data is unnecessary for analysis. In addition, it was difficult to know what kind of information the sensing data required by the service is provided, and in which device the information is provided, and it was difficult to change the collected data even if the sensing data required for analysis is changed.

### DISCLOSURE OF INVENTION

### Technical Problem

According to an embodiment of the disclosure, there is provided an electronic apparatus that selectively collects sensing data from sensing apparatuses and controls another electronic apparatus based on the collected sensing data, and a method for controlling another electronic apparatus in the electronic apparatus.

According to an embodiment, there is provided a method for controlling another electronic apparatus in an electronic apparatus, the method including receiving a voice, identifying a control command corresponding to the received voice, identifying at least one type of sensing data related to the identified control command, requesting sensing data from a sensing apparatus corresponding to the at least one type of sensing data which is identified, and controlling at least one other electronic apparatus related to the identified control command based on sensing data received in response to the request.

### Solution to Problem

The electronic apparatus may be configured to store a matching table indicating a correlation between information on a type of sensing data that at least one sensing apparatus connected to the electronic apparatus is capable of providing and at least one control command for controlling another electronic apparatus, and the identifying may include identifying at least one type of sensing data related to the identified control command based on the stored matching table.

The method may further include, based on a new sensing apparatus being connected to the electronic apparatus, requesting information on a type of sensing data that the new sensing apparatus is capable of providing, from the new sensing apparatus, and receiving information on a type of sensing data that the new sensing apparatus is capable of providing from the new sensing apparatus; and updating the matching table based on information on a type of sensing data that the new sensing apparatus is capable of providing.

The method may further include obtaining information on a type of sensing data that at least one sensing apparatus connected to the electronic apparatus is capable of providing, from an external server.

The method may further include, based on sensing data being continuously received from a first sensing apparatus which does not correspond to the at least one type of sensing data which is identified, requesting the first sensing apparatus to stop transmitting sensing data.

The method may further include, based on a control command identified based on a voice which is received after requesting the first sensing apparatus to stop transmitting sensing data, being related to a type of sensing data corresponding to the first sensing apparatus, requesting the first sensing apparatus to resume transmission of sensing data.

The identifying a type of sensing data may include, based on the identified control command corresponding to a sleep mode, identifying temperature and illuminance as a type of sensing data related to the identified control command, and the requesting may include requesting sensing data from a temperature sensing apparatus and an illuminance sensing apparatus, and the controlling may include controlling a temperature control apparatus and a lighting apparatus for maintaining predetermined temperature and predetermined illuminance regarding the sleep mode based on sensing data received from the temperature sensing apparatus and the illuminance sensing apparatus.

The method may further include, based on sensing data being continuously received from an occupancy detecting sensor which does not correspond to the identified type of sensing data, requesting the occupancy detecting sensor to stop transmitting sensing data.

According to an embodiment, there is provided an electronic apparatus including a microphone, a communicator, a memory configured to store at least one computer executable instruction, and a processor configured to execute the at least one computer executable instruction, and the processor may be configured to identify a control command corresponding to a voice which is received through the microphone, identify at least one type of sensing data related to the identified control command, control the communicator to transmit a request for sensing data to a sensing apparatus corresponding to the at least one type of sensing data which is identified, and control at least one other electronic apparatus related to the identified control command based on sensing data received in response to the request through the communicator.

The memory may be configured to store a matching table indicating a correlation between information on a type of sensing data that at least one sensing apparatus connected to the electronic apparatus is capable of providing and at least one control command for controlling another electronic apparatus, and the processor may be configured to identify at least one type of sensing data related to the identified control command based on the stored matching table.

The processor may be configured to, based on a new sensing apparatus being connected to the electronic apparatus, request information on a type of sensing data that the new sensing apparatus is capable of providing, from the new sensing apparatus, and receive information on a type of sensing data that the new sensing apparatus is capable of providing from the new sensing apparatus, and update the matching table based on information on a type of sensing data that the new sensing apparatus is capable of providing.

The processor may be configured to receive information on a type of sensing data that at least one sensing apparatus connected to the electronic apparatus is capable of providing from an external server through the communicator.

The processor may be configured to, based on sensing data being continuously received from a first sensing apparatus which does not correspond to the at least one type of sensing data which is identified, control the communicator to transmit a request to the first sensing apparatus to stop transmitting sensing data.

### Advantageous Effects of Invention

The processor may be configured to, based on a control command identified based on a voice which is received after requesting the first sensing apparatus to stop transmitting sensing data, being related to a type of sensing data corresponding to the first sensing apparatus, control the communicator to transmit a request to the first sensing apparatus to resume transmission of sensing data.

The processor may be configured to, based on the identified control command corresponding to a sleep mode, identify temperature and illuminance as a type of sensing data related to the identified control command, control the communicator to transmit a request for sensing data to a temperature sensing apparatus and an illuminance sensing apparatus, and control a temperature control apparatus and a lighting apparatus for maintaining predetermined temperature and predetermined illuminance regarding the sleep mode based on sensing data received from the temperature sensing apparatus and the illuminance sensing apparatus through the communicator.

The processor, based on sensing data being continuously received from an occupancy detecting sensor which does not correspond to the identified type of sensing data, may control the communicator to transmit a request to the occupancy detecting sensor to stop transmitting sensing data.

### BRIEF DESCRIPTION OF DRAWINGS

FIG. 1 is a view illustrating a smart system according to an embodiment of the disclosure;

FIG. 2 to FIG. 3 are views illustrating various services provided by a smart system according to an embodiment of the disclosure;

FIG. 4 to FIG. 5 are views illustrating a function of an electronic apparatus according to an embodiment of the disclosure;

FIG. 6 is a view illustrating an example of a sensing data model defined in the disclosure;

FIG. 7 is a flow chart illustrating a process for registering a data model according to an embodiment of the disclosure;

FIG. 8 is a view illustrating a process for searching a data model according to an embodiment of the disclosure;

FIG. 9 is a view illustrating a configuration of an electronic apparatus according to an embodiment of the disclosure; and

FIG. 10 is a flowchart illustrating a method for controlling another electronic apparatus in an electronic apparatus according to an embodiment of the disclosure.

### BEST MODE FOR CARRYING OUT THE INVENTION

Hereinafter, various embodiments are described with reference to attached drawings. However, it should be understood that the disclosure is not limited to the specific embodiments described hereinafter, but includes various modifications, equivalents, and/or alternatives of the embodiments of the disclosure. In relation to explanation of the drawings, similar drawing reference numerals may be used for similar constituent elements.

In the description, the term “has”, “may have”, “includes” or “may include” indicates existence of a corresponding feature (e.g., a numerical value, a function, an operation, or a constituent element such as a component), but does not exclude existence of an additional feature.

In the description, the term “A or B”, “at least one of A or/and B”, or “one or more of A or/and B” may include all possible combinations of the items that are enumerated together. For example, the term “A or B” or “at least one of A or/and B” may designate (1) at least one A, (2) at least one B, or (3) both at least one A and at least one B.

In the description, the terms “first, second, and so forth” are used to describe diverse elements regardless of their order and/or importance and to discriminate one element from other elements, but are not limited to the corresponding elements. For example, a first user appliance and a second user appliance may indicate different user appliances regardless of their order or importance. For example, a first user appliance and a second user appliance may indicate different user appliances regardless of their order or importance. For example, without departing from the scope as described herein, a first element may be referred to as a second element, or similarly, a second element may be referred to as a first element.

In the embodiment of the disclosure, the term “module,” “unit,” or “part” is referred to as an element that performs at least one function or operation, and may be implemented with hardware, software, or a combination of hardware and software. In addition, a plurality of “modules,” a plurality of “units,” a plurality of “parts” may be integrated into at least one module or chip except for a “module,” a “unit,” or a “part” which has to be implemented with specific hardware, and may be implemented with at least one processor.

If it is described that a certain element (e.g., first element) is “(operatively or communicatively) coupled with/to” or is “connected to” another element (e.g., second element), it should be understood that the certain element may be connected to the other element directly or through still another element (e.g., third element). Meanwhile, when it is mentioned that one element (e.g., first element) is “directly coupled” with or “directly connected to” another element (e.g., second element), it may be understood that there is no element (e.g., third element) between one element and another element.

The expression “configured to (or set to)” used in one or more embodiments may be replaced with “suitable for,” “having the capacity to,” “designed to,” “adapted to,” “made to,” or “capable of” according to a context. The term “configured to (set to)” does not necessarily mean “specifically designed to” in a hardware level. Under certain circumstances, the term “device configured to” may refer to “device capable of” doing something together with another device or components. For example, the phrase “processor configured to perform A, B, and C” may denote or refer to a dedicated processor (e.g., embedded processor) for performing the corresponding operations or a generic-purpose processor (e.g., central processing unit (CPU) or application processor) that can perform the corresponding operations through execution of one or more software programs stored in a memory device.

The terms used in the description are used to merely describe a specific embodiment, but may not intend to limit the scope of other embodiments. Unless otherwise defined specifically, a singular expression may encompass a plural expression. All terms including technical and scientific terms used in the description could be used as meanings commonly understood by those ordinary skilled in the art to which the disclosure belongs. The terms that are used in the disclosure and are defined in a general dictionary may be used as meanings that are identical or similar to the meanings of the terms from the context of the related art, and they are not interpreted ideally or excessively unless they have been clearly and specially defined. According to circumstances, even the terms defined in the embodiments of the disclosure should not be interpreted as excluding the embodiments of the disclosure.

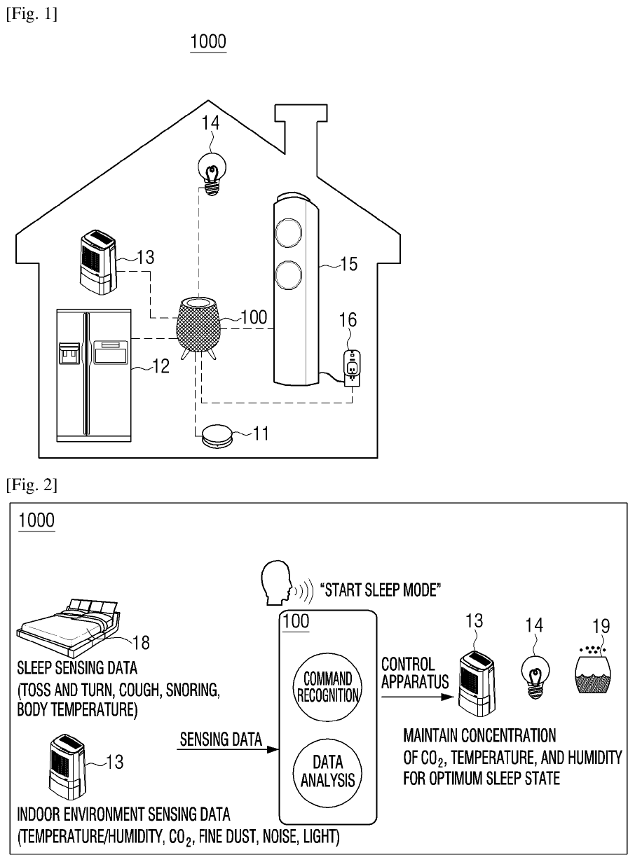

FIG. 1 is a view illustrating a smart system 1000 according to an embodiment of the disclosure.

Referring to FIG. 1, the smart system 1000 may include IoT apparatuses 11 to 16 and an electronic apparatus 100.

The electronic apparatus 100 may not be limited when including a communication function or a data process function, but may be realized as an apparatus such as a smart phone, a tablet personal computer (PC), a mobile phone, a video phone, a speaker, an artificial intelligence (AI) speaker, an e-book reader, a desktop PC, a laptop PC, a netbook computer, a workstation, a server, a personal digital assistant (PDA), a portable multimedia player (PMP), a mobile medical device, a camera, or a wearable device, for example.

In some embodiments, the electronic apparatus 100 may be a home appliance. The home appliance may be, for example, a television, a digital video disk (DVD) player, an audio, a refrigerator, an air conditioner, a cleaner, an oven, a microwave, a washing machine, an air cleaner, a set top box, a home automation control panel, a security control panel, a TV box (e.g., Samsung HomeSync™, Apple TV™ and Google TV™), a game console (e.g., Xbox™ and PlayStation™), an e-dictionary, an e-key, a camcorder, an e-frame or an IoT apparatus (e.g., a bulb, sensors, an electric or gas meter, a sprinkler, a fire alarm, a thermostat, a streetlight, a toaster, sporting goods, a hot water tank, a heater, a boiler, etc.).

FIG. 1 illustrates that the electronic apparatus 100 is realized as an AI speaker. The AI speaker is an apparatus that reacts a voice command of a user, and may include a microphone and an AI interactive system.

According to an embodiment, the electronic apparatus 100 may be an apparatus in which edge computing is realized. The edge computing is a technology for compensating the limit of cloud computing based on an existing server. As the amount of IoT apparatuses grows and real time processing becomes important, the cloud computing based on a server reaches a limit. In the edge computing technology, the local apparatus, not a server, may perform a part or all of the computing operation according to circumstances, which has been performed in the server. The edge computing is a technology which performs distributed processing on data in a peripheral area of IoT apparatuses or in an IoT apparatus itself. Accordingly, data processing may be performed faster by the edge computing than performed by an existing cloud computing technology.

The electronic apparatus 100 may be connected to the IoT apparatuses 11 to 16 in the smart system 1000 in a wired or wireless communication method. In addition, the electronic apparatus 100 may perform controlling, management, and connection of the IoT apparatuses 11 to 16 in the smart system 1000. The electronic apparatus 100 may exist as an individual apparatus or may be mounted on another apparatus.

The electronic apparatus 100 may serve as a gateway which performs interconnection or arbitration of the network in home and an external network. For example, the electronic apparatus 100 may transmit the control command provided from an external apparatus to the IoT apparatuses 11-16, or collect the state information of the IoT apparatuses 11 to 16 and transmit the information to an external apparatus.

In addition, the electronic apparatus 100 may receive a voice command or a control command from a user terminal apparatus and control the IoT apparatuses 11 to 16, and collect the state information of the IoT apparatuses 11 to 16 and transmit the information to the user terminal apparatus. The user terminal apparatus may be for example, a smart phone, a desktop computer, a note book, a tablet PC, a PDA, etc.

The IoT apparatuses 11 to 16 may be any electronic apparatuses in which a communication function is embedded. For example, the realized examples of the above described electronic apparatus 100 may be the realized example of the IoT apparatuses 11 to 16. Meanwhile, in the disclosure, the IoT apparatus may be indicated as an electronic apparatus as another word. In the relation of the electronic apparatus 100, the IoT apparatuses may be called ‘another electronic apparatus’. Meanwhile, the number and type of the IoT apparatuses 11 to 16 illustrated in FIG. 1 are merely an example, and various IoT apparatuses may be included in the smart system 1000 described in the embodiment.

According to an embodiment, the IoT apparatuses 11 to 16 may include a sensor such as a temperature/illuminance sensor 11, a power measurement sensor 16, etc., and a home appliance such as a refrigerator 12, an air cleaner 13, a lighting apparatus 14, an air conditioner 15, etc. as illustrated in FIG. 1. Of course, the apparatus such as the refrigerator 12, the air cleaner 13, the lighting apparatus 14, the air conditioner 15, etc. may have a sensing function. For example, the refrigerator 12 may include various sensors related to the function of the refrigerator such as a gas sensor, a temperature sensor, a humidity sensor, an operation detection sensor, etc., and the air cleaner 13 may include various sensors for sensing atmosphere environment such as a temperature sensor, a humidity sensor, a CO2 sensor, a dust sensor, etc. In the disclosure, all apparatuses including the sensing function may called a sensing apparatus.

Meanwhile, FIG. 1 illustrates apparatuses in home, but the embodiment is not only applied to a home environment but may also be applied to any environments such as a factory, a company, etc. in which IoT apparatuses are used.

Meanwhile, it has been described that there is one electronic apparatus 100, but the number of the electronic apparatus 100 may be more than one which are divided according to the function. For example, the apparatus that recognizes user's voice and the apparatus that analyzes the data received from IoT apparatuses 11 to 16 may exist separately. Any other combinations are possible.

The electronic apparatus 100 may receive sensing data from the apparatuses including a sensing function among IoT apparatuses in the smart system 1000 (hereinafter referred to as a sensing apparatus), and based on this, may control at least one of IoT apparatuses according to a user command.

Especially, the electronic apparatus 100 may receive sensing data by sorting out the required type of sensing data, not manually receive the sensing data from the sensing apparatuses. In addition, the electronic apparatus 100 may determine various circumstances by analyzing the received sensing data and provide an appropriate service to correspond to the determined circumstance.

FIG. 2 is a view illustrating a sleep care service of the electronic apparatus 100 according to an embodiment of the disclosure.

Referring to FIG. 2, the smart system 1000 may include IoT apparatuses such as a sleep sensor 18 disposed at a bed, the air cleaner 13, the lighting apparatus 14, a humidifier 19, and the electronic apparatus 100.

The electronic apparatus 100 may receive sensing data from the sleep sensor 18 for collecting the data regarding sleep and various types of sensors in the air cleaner 13.

The electronic apparatus 100 may include a microphone and receive a voice command from a user through the microphone. If the electronic apparatus 100 receives a voice command of “start sleep mode” from a user, the electronic apparatus 100 may receive sensing data from the apparatuses which may provide sensing data related to the sleep mode and analyze the data.

For example, the electronic apparatus 100 may analyze the sensing data received from the sleep sensor 18 and identify the sleep state of a user, and may identify the indoor temperature, humidity, concentration of CO2, amount of fine dust, noise, amount of light, etc. based on the sensing data received from the air cleaner 13.

The electronic apparatus 100 may control the IoT apparatuses 13, 14, and 19 to make the environment condition for an optimum sleep state according to the current sleep state of a user and the current atmosphere state which are identified as a result of an analysis of the sensing data. For example, the electronic apparatus 100 may control the lighting apparatus 14 to lower the brightness if a user tosses and turns a lot, and may control the air conditioner 15 to maintain the temperature of 24-26° C. which is set as the optimum temperature in the sleep mode, if the current temperature is 28° C.

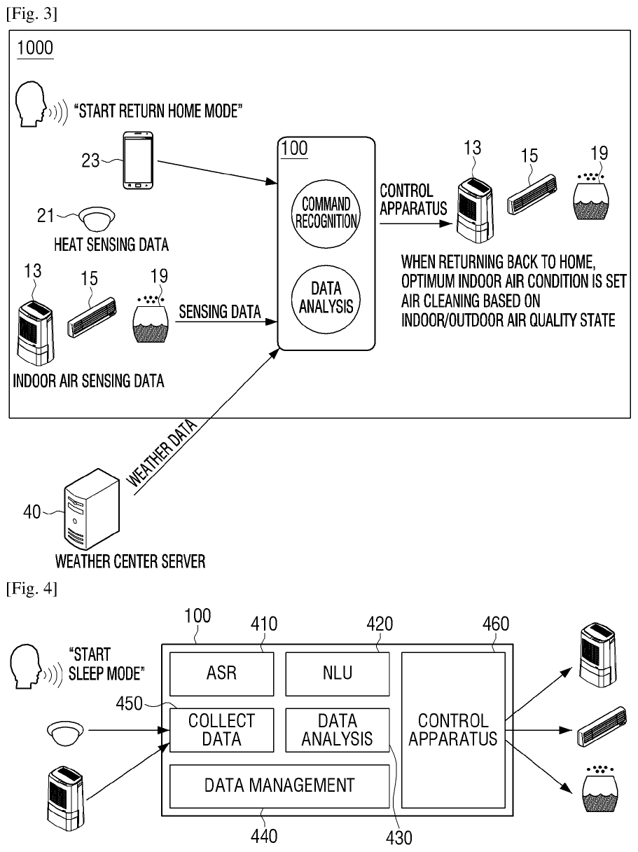

FIG. 3 is an air conditioning service of the electronic apparatus 100 according to another embodiment of the disclosure.

Referring to FIG. 3, the smart system 1000 may include the IoT apparatuses such as a heat sensor 21, the air cleaner 13, the air conditioner 15, the humidifier 19, and the electronic apparatus 100, and the user terminal apparatus 23 which is outside of a home. The voice received through the microphone of the user terminal apparatus 23 outside the home may be transmitted to the electronic apparatus 100.

The electronic apparatus 100 may analyze the received voice and recognize the command corresponding to the voice, and identify the sensing apparatus providing sensing data related to the recognized command. If the sensing apparatus that provides sensing data related to a return home mode are the heat sensor 21, the air cleaner 13, the air conditioner 15, and the humidifier 19, the electronic apparatus 100 may receive sensing data from the above apparatuses and analyze the sensing data. In addition, it is possible that the data is received from an outside in relation to the recognized command. For example, the electronic apparatus 100 may receive weather data from the weather center server 40.

As a result of analysis of the sensing data and the data received from an outside, the electronic apparatus 100 may control the air cleaner 13, the air conditioner 15, and the humidifier 19 so that the indoor air become an optimum state when a user returns to the home.

FIG. 4 is a view illustrating a detailed functions of the electronic apparatus 100 according to an embodiment of the disclosure.

Referring to FIG. 4, the electronic apparatus 100 may include an automatic speech recognition (ASR) module 410, a natural language understanding (NLU) module 420, a data analysis module 430, a data management module 440, a data collection module 450, and an apparatus control module 460.

The ASR module 410 may convert the user's utterance into text data. The ASR module 410 may include an acoustic model and a language model. For example, the acoustic model may include information related to a vocalization and a language model may include unit phoneme information and the information on a combination of the unit phoneme information. The ASR module 410 may convert the user's utterance into text data using the information related to the vocalization and the information on the unit phoneme information.

The NLU module 420 may idnetify the intension of a user by performing syntactic analysis or semantic analysis. The syntactic analysis may divide the user input into a syntactic unit (e.g., a word, a phrase, a morpheme, etc.) and identify which syntactic unit the divided unit includes. The semantic analysis may be performed by using semantic matching, rule matching, formula matching, etc.

The NLU module 420 may identify the meaning of the word extracted from a user input by using the feature of language (e.g., a syntactic element) such as a morpheme and a phrase, and match the identified meaning of the word to a domain and an intention so that the intention of the user may be determined.

For example, the NLU module 420 may obtain a dialog act, a main act, and an entity from user's utterance. Here, the dialog act refers to the intended action of a speaker for performing the purpose of the conversation included in the utterance, and indicates whether the utterance of a user is a request for action, which variable value the speaker requests an audience (WH-Question), whether the speaker requires the audience the answer of YES/NO (YN-Question), whether the speaker informs an audience of information, etc. The main action refers to semantic information that represents an act desired in the corresponding utterance through a dialogue in a specific domain. In addition, the entity is the information added for specifying the meaning of the action intended in the specific domain.

For example, if user's utterance is “start a sleep mode”, the NLU module 420 may determine that the dialog act of the users' utterance is a request for action, the main act is “apparatus control”, and the entity is “sleep mode”.

The data analysis module 430 may identify the control command corresponding to the user's intention determined in the NLU module 420, and identify at least one type of sensing data related to the identified control command.

According to an embodiment, the data management module 440 may store a matching table indicating the correlation of the information on the type of sensing data corresponding to the sensing apparatus connected to the electronic apparatus 100 and the control command for controlling another electronic apparatus. For example, the matching table may include a control command ‘start a sleep mode’, and ‘temperature’, ‘humidity’, and ‘illuminance’ as types of sensing data related thereto.

The data analysis module 430 may identify at least one type of sensing data related to the control command by referring to the matching table stored in the data management module 440.

In addition, the data analysis module 430 may obtain information on the sensing apparatus corresponding to at least one type of data related to the control command from the data management module 440. According to an embodiment, the data management module 440 may store the information on the type of sensing data for each sensing apparatus. For example, the sensing apparatus corresponding to the type of sensing data, ‘humidity’, may be a humidifier or an air conditioner which has a humidity sensing function. As in the above, the information on which type of sensing data each of the sensing apparatus can sense is stored in the data management module 440. The data analysis module 430 may obtain information on the sensing apparatus corresponding to at least one type of sensing data related to a specific control command based on the information stored in such data management module 440.

The data analysis module 430 may set the information on the sensing apparatus from which sensing data will be received and the sensing apparatus from which sensing data will not be received in the data management module 440 so as to receive the sensing data from the sensing apparatus corresponding to the type of sensing data related to the control command and not to receive the sensing data from the sensing apparatus which does not correspond to the type of sensing data related to the control command. For example, the data management module 440 may store the information indicating the sensing apparatus to which the sensing data will be requested and the sensing apparatus to which the sensing data will not be requested. As in the above, based on the information stored in the data management module 440, the data collection module 450 may request sensing data from a specific sensing apparatus and request another specific sensing apparatus to stop transmitting the sensing data.

In addition, the data analysis module 430 may transmit the analysis result of the received sensing data to the apparatus control module 460 and the apparatus control module 460 may control at least one other electronic apparatus related to the control command according to the analysis result of the sensing data. The apparatus control module 460 may transmit a control signal to the sensing apparatus. For example, the data analysis module 430 may determine the current temperature, humidity, and illuminance in real time based on the sensing data, and the apparatus control module 460 may transmit the control signal to maintain the temperature, humidity, and illuminance for an optimum sleep state to an air cleaner, an air conditioner, a humidifier, etc.

Meanwhile, the data analysis module 430 may analyze data using the analysis model trained by an AI algorithm. For example, after the apparatus control module 460 controls an apparatus, the data analysis module 430 may analyze the change of circumstance in real time as the sensing data from the sensing apparatuses, and retrain the analysis model. For example, the data analysis module 430 may identify the correlation of data such as optimum temperature, humidity, illuminance, etc. by monitoring the change of quality of sleep after operating as a sleep mode, identify the type of sensing data required and not required for the sleep mode, and retrain the analysis model based on the identified result.

Some of the modules illustrated in FIG. 4 is not included in the electronic apparatus 100, and may be mounted on another external apparatus. For example, the ASR module 410 and the NLU model 420 may be mounted on an external apparatus, and a voice may be analyzed in the external apparatus, and the information on the control command corresponding to the voice may be transmitted to the electronic apparatus 100.

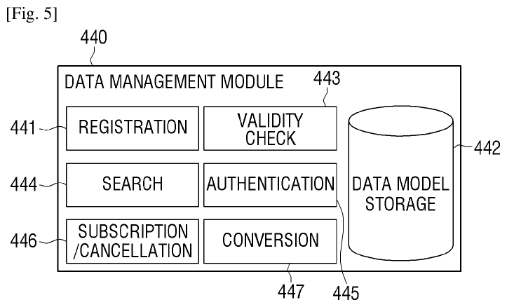

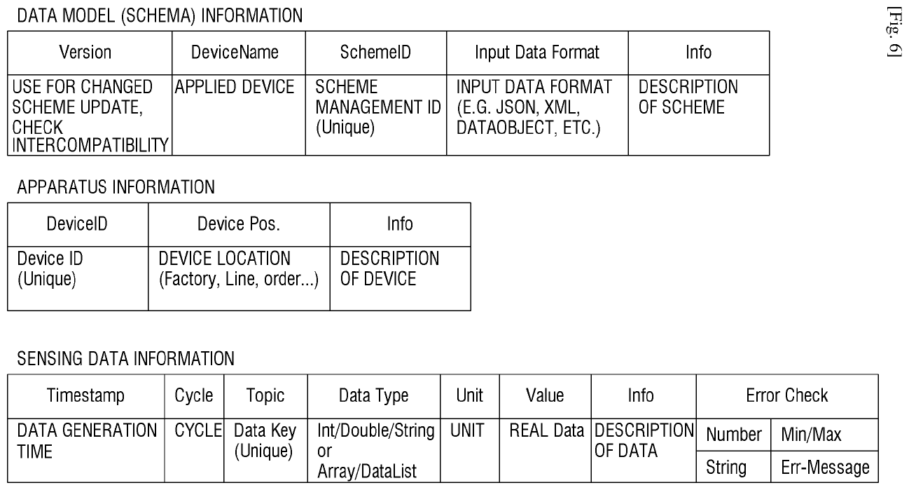

FIG. 5 is a view illustrating a detailed function of the data management module 440 according to an embodiment of the disclosure.

Referring to FIG. 5, the data management module 440 may include a registration unit 441, a data model storage 442, a validity check unit 443, a search unit 444, an authentication unit 445, a subscription/cancellation unit 446, and a converter 447.

First, the registration unit 441 may register the data model of each sensor apparatus at the data model storage 442. The data model indicates apparatus information of the sensor apparatus and configuration contents of the sensing data, and for example, may include the information illustrated in FIG. 6. That is, the data model is information on the sensing apparatus such as what apparatus the sensing apparatus is, what is sensed by the sensing apparatus, how often sensing is performed, and what is a type of sensing data. The data model may be named as data configuration information or specification information.

The validity check unit 443 may perform validation check of the registered data model. According to an embodiment, the validity check unit 443 may check whether there is a dually registered data model (e.g., determined by comparing an apparatus ID), and check a connection state of the sensing apparatus.

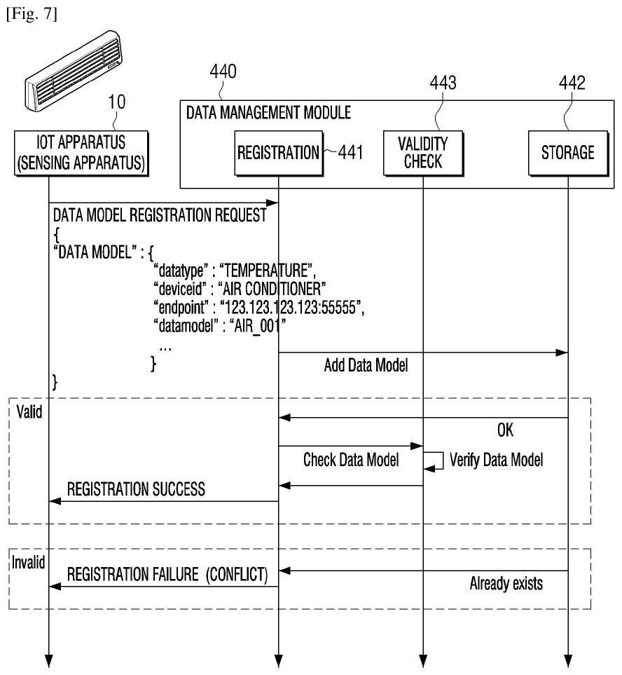

FIG. 7 is a view illustrating a data model registration process.

Referring to FIG. 7, the sensing apparatus 10 may transmit the data model registration request to the electronic apparatus 100. In response to the request, the data management module 440 of the electronic apparatus 100 may proceed with a registration process.

Specifically, according to an embodiment, the sensing apparatus 10 may transmit the data model registration request to the electronic apparatus 100 when initially being connected to the electronic apparatus 100. When the data model registration request is received, the registration unit 441 may register the data mode at the data model storage 442. Then, the validity check unit 443 may confirm whether a data model of the corresponding sensing apparatus 10 is already in the data model storage 442 and check the validity of the data model. If the data model is valid, the registration unit 441 may transmit the registration success message to the sensing apparatus 10. If the data model is invalid, the registration unit 441 may transmit the registration failure message to the sensing apparatus 10.

Returning back to FIG. 5, the search unit 444 may search various pieces of information stored in the data model storage 442 according to the request.

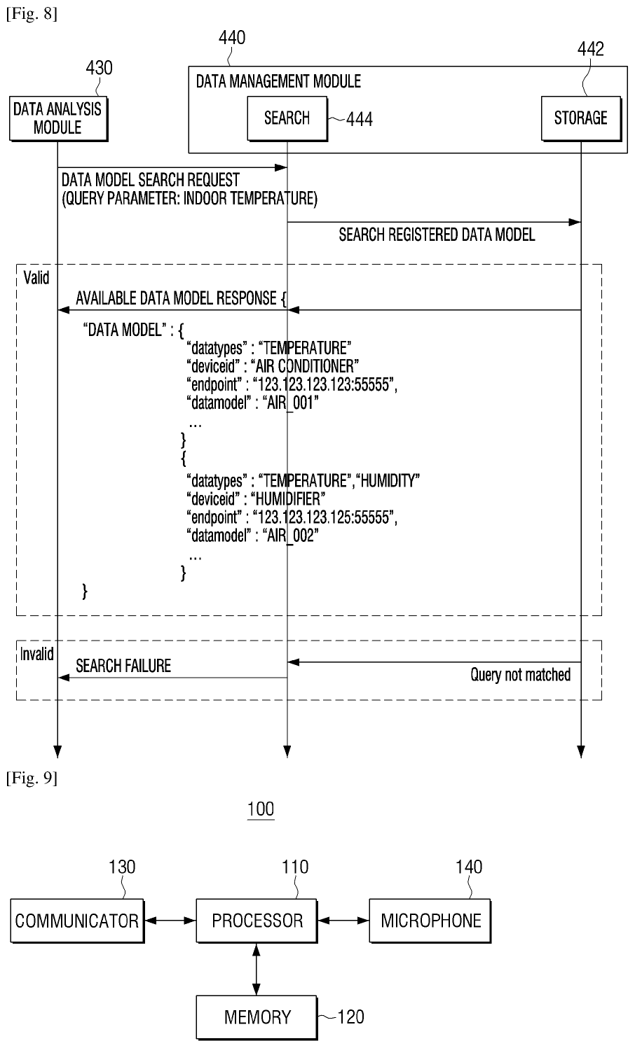

FIG. 8 is a view illustrating an example of a process for searching a data model.

Referring to FIG. 8, if a search request regarding the sensing apparatus corresponding to a specific sensing data type (e.g., indoor temperature) is received from the data analysis module 430, the search unit 444 may perform search in the data model storage 442 and if the search is succeeded, transmit the search result to the data analysis module 430. In FIG. 8, the search result including the information on an air conditioner and a humidifier as sensing apparatuses that sense temperature as a type of sensing data, is transmitted to the data analysis module 430. If the search is failed, the failure of search is informed.

Returning back to FIG. 5, the authentication unit 445 may confirm whether the search request is from an authorized service or an application. Only in response to the authorized request, the data model search is allowed. In this case, the account information, an authentication certificate, a security key, etc. may be used.

According to the analysis result of the data analysis module 430, the subscription/cancellation unit 446 may manage information on from which sensing apparatus the sensing data is received (subscribed) or not received (cancelled). The data collection module 450 may receive sensing data only from a subscribed sensing apparatus and do not receive sensing data from a cancelled sensing apparatus based on the information stored in the subscription/cancellation unit 446.

The converter 447 may convert the received sensing data into an appropriate format (XML, JSON, etc.) and provide the converted data to the data analysis module 430.

At least one of the ASR module 410, the NLU module 420, the data analysis module 430, the data management module 440, the data collection module 450, the apparatus control module 460, the registration unit 441 in the data management module, the validity check unit 443, the search unit 444, the authentication unit 445, the subscription/cancellation unit 446 or the converter 447 illustrated in FIGS. 4, 5, 7, and 8 may be made in a hardware form and mounted on one apparatus, or mounted on each of different apparatuses. In addition, at least one of the above may be implemented as a software module (or a program module including instructions). In this case, the software module may be stored in a non-transitory computer readable medium. In addition, in this case, at least one software module may be provided by an operating system (O/S) or a predetermined application. Alternatively, a part of at least one software module may be provided by an O/S, and the remaining part may be provided by a predetermined application.

FIG. 9 is a block diagram illustrating a configuration of the electronic apparatus 100 according to an embodiment of the disclosure.

Referring to FIG. 9, the electronic apparatus 100 may include a processor 110, a memory 120, a communicator 130, and a microphone 140.

The processor 110 controls overall operations of the electronic apparatus 100. For example, the processor 110 may control a number of hardware or software elements connected to the processor 110 by driving an operating system or application, and perform various data processing and calculations. The processor 110 may be one of a central processing unit (CPU) or a graphics-processing unit (GPU), or both CPU and GPU. The processor 110 may be implemented as at least one of a general processor, a digital signal processor, an application specific integrated circuit (ASIC), a system on chip (SoC) or a microcomputer (MICOM).

The memory 120, for example, may include a built-in memory or an external memory. The built-in memory, for example, may include at least one of a volatile memory (e.g., dynamic random access memory (DRAM), static RAM (SRAM), or synchronous dynamic RAM (SDRAM), etc.) or a non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive or solid state drive (SSD)). The external memory may include a flash drive, for example, compact flash (CF), secure digital (SD), micro-SD, mini-SD, extreme digital (XD), a multi-media card (MMC), a memory stick and the like.

The memory 120 may store various types of data, programs, or applications for driving and controlling the electronic apparatus 100. The program stored in the memory 120 may include more than one computer executable instructions. The memory 120 may include a software and/or firmware composed of more than one module. The module may correspond to a set of instructions. The program (more than one instructions) or application stored in the memory 120 may be executed by the processor 110.

The communicator 130 is an element that performs communication with various types of external devices. The communicator 130 may communicate with an external apparatus in a wireless communication method such as Wi-Fi, Bluetooth, near field communication (NFC), infrared data association (IrDA), radio frequency identification (RFID), ultra wideband (UWB), Wi-Fi direct, Z-wave, Zigbee, 4LoWPAN, GPRS, Weightless, Digital Living Network Alliance (DLNA), ANT+, Digital Enhanced Cordless Telecommunications (DECT), wireless local area network (WLAN), Global System for Mobile communications (GSM), Universal Mobile Telecommunication System (UMTS), Wireless Broadband (WiBRO), etc. According to another embodiment, the communicator 130 may communicate with an external apparatus in a wired communication method. The wired communication may include, for example, a universal serial bus (USB), an Ethernet communication method, etc. The communicator 130 may be implemented as at least one of a communication chip, a transceiver, a communication port, etc.

The microphone 140 may receive sound. The microphone 140 may convert the received sound into an electrical signal. The microphone 140 may be embedded in the electronic apparatus 100 or be separated from the electronic apparatus 100. The separated microphone 140 may be connected to the electronic apparatus 100 in a wired or wireless manner.

The memory 120 may store at least one of the ASR module 410, the NLU module 420, the data analysis module 430, the data management module 440, the data collection module 450, the apparatus control module 460, the registration unit 441 in the data management module, the validity check unit 443, the search unit 444, the authentication unit 445, the subscription/cancellation unit 446 or the converter 447 illustrated in FIGS. 4, 5, 7, and 8, and which are realized as a software module, and the processor 110 may perform at least one operation of the ASR module 410, the NLU module 420, the data analysis module 430, the data management module 440, the data collection module 450, the apparatus control module 460, the registration unit 441 in the data management module, the validity check unit 443, the search unit 444, the authentication unit 445, the subscription/cancellation unit 446 or the converter 447 illustrated in FIGS. 4, 5, 7, and 8 by executing the software module stored in the memory 120.

For example, the processor 110 may identify the control command corresponding to the voice received through the microphone 140 and at least one type of sensing data related to the identified control command.

Meanwhile, instead of that the electronic apparatus 100 directly receives and analyzes a voice, it is possible that an external apparatus analyzes a voice and only the analysis result is transmitted to the electronic apparatus 100. In this case, the microphone 140 may not be included in the electronic apparatus 100.

The processor 110 may identify at least one type of sensing data related to the control command, control the communicator 130 to transmit the data request to the sensing apparatus corresponding to at least one type of sensing data which is identified, and control at least one other electronic apparatus related to the recognized control command based on the sensing data received through the communicator 130 as a response to the request.

The memory 120 may store a matching table indicating the correlation between the information on the type of sensing data that at least one sensing apparatus connected to the electronic apparatus 100 is capable of providing, and at least one control command for controlling another electronic apparatus. The matching table may be updated according to a user input or automatically.

The processor 110 may identify at least one type of sensing data related to the control command corresponding to a user voice based on the information of the matching table.

According to an embodiment, the information on the type of sensing data that at least one sensing apparatus connected to the electronic apparatus 100 is capable of providing, may be provided from an external server, or may be provided directly from the sensing apparatus.

For example, if a new sensing apparatus is connected to the electronic apparatus 100, the processor 110 may request information on a type of sensing data that the new sensing apparatus is capable of providing, from the new sensing apparatus, and receive information on the type of sensing data that the new sensing apparatus is capable of providing from the new sensing apparatus through the communicator 130, and update the matching table information based on the received information.

The new sensing apparatus may provide the data model described above, including the information on the type of sensing data to the electronic apparatus 100.

Meanwhile, if the sensing data is continuously received from the sensing apparatus corresponding to the type of sensing data which is not related to the control command corresponding to the user voice, the processor 110 may control the communicator 130 to transmit a request to stop transmitting the sensing data to the sensing apparatus.

After requesting the specific sensing apparatus to stop transmitting sensing data, if the sensing data is required from the sensing apparatus, it is possible to request the transmission of the sensing data again, needless to say. That is, if a control command identified based on a voice received after requesting the sensing apparatus to stop transmitting sensing data, is related to a type of sensing data corresponding to the sensing apparatus, the processor 110 may request the sensing apparatus to resume the transmission of sensing data.

As in the above, the processor 110 may automatically select and request the sensing data required for analyzing a circumstance when there is user's voice command. In addition, this selection operation may be performed by a runtime.

A sleep mode will be described as a specific example in which sensing data is requested to the sensing apparatus which is required by circumstances. For example, if the control command identified based on a user voice corresponds to a sleep mode, the processor 110 may identify temperature and illuminance as a type of sensing data related to the identified control command, control the communicator 130 to transmit a request for sensing data to a temperature sensing apparatus and an illuminance sensing apparatus, and control a temperature control apparatus and a lighting apparatus for maintaining predetermined temperature and illuminance regarding the sleep mode based on sensing data received from the temperature sensing apparatus and the illuminance sensing apparatus through the communicator 130. For example, the processor 110 may control the communicator 130 to transmit the signal for controlling the temperature control apparatus to maintain the predetermined temperature regarding the sleep mode to the temperature control apparatus, and control the communicator 130 to transmit the control signal for controlling a lighting apparatus to maintain the predetermined illuminance regarding the sleep mode to the lighting apparatus.

In this case, if sensing data is continuously received from an occupancy detecting sensor which does not correspond to the identified type of sensing data, the processor 110 may control the communicator 130 to transmit a request to stop transmitting sensing data to the occupancy detecting sensor. That is, detecting the occupancy is not required for operating as a sleep mode, the occupancy detecting sensor is requested to stop transmitting the sensing data.

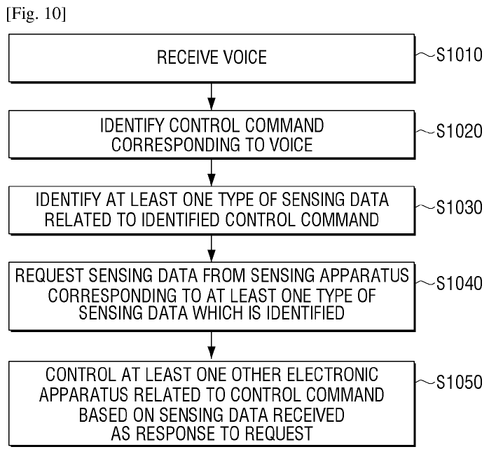

FIG. 10 is a flowchart illustrating a method for controlling another electronic apparatus in an electronic apparatus according to an embodiment of the disclosure. The flowchart illustrated in FIG. 10 is configured with the operations processed in the electronic apparatus 100 described in the disclosure. Accordingly, the description regarding the electronic apparatus 100 can be applied to the flowchart illustrated in FIG. 10 even if the description is omitted in the followings.

Referring to FIG. 10, the electronic apparatus may receive a voice in operation S1010. If a voice reception function is not included in the electronic apparatus, a voice may be received from an external apparatus and the voice data may be transmitted to the electronic apparatus. It is possible to receive another user manipulation command which is not based on a voice. For example, the electronic apparatus may include a button, a touch pad, a touch screen, etc. with which a user manipulation input may be received.

If a voice is received, the electronic apparatus may identify the control command corresponding to the voice in operation S1020. The electronic apparatus includes the function with which a voice can be recognized and understood and thus, the control command may be identified. If such function is not included in the electronic apparatus, it is possible that another external apparatus processes a voice and the result thereof is transmitted to the electronic apparatus.

In addition, the electronic apparatus may identify at least one type of sensing data related to the identified control command in operation S1030. According to an embodiment, the electronic apparatus may store a matching table indicating a correlation between information on a type of sensing data that at least one sensing apparatus connected to the electronic apparatus is capable of providing and at least one control command for controlling another electronic apparatus, and identify at least one type of sensing data related to the identified control command based on the stored matching table.

The information on the type of sensing data that the sensing apparatus is capable of providing may be provided from the sensing apparatus according to the request of the electronic apparatus, but the program may be set in advance so that even if there is no request from the electronic apparatus, if the sensing apparatus is newly connected to the electronic apparatus, the sensing apparatus automatically provides such information to the electronic apparatus. The electronic apparatus may update a pre-stored matching table with the information provided from the newly connected sensing apparatus. Meanwhile, the electronic apparatus may receive information on the type of data that the sensing apparatus is capable of providing, from the external server that generally manages the apparatus other than the sensing apparatus, for example, the apparatuses in the smart system 1000.

If at least one type of sensing data related to the control command is identified, the electronic apparatus may request the sensing data from the sensing apparatus corresponding to the at least one type of sensing data which is identified, in operation S1040.

In this case, if sensing data is continuously received from a specific sensing apparatus which does not correspond to the at least one type of sensing data which is identified, the specific sensing apparatus may be requested to stop transmitting sensing data. That is, the sensing data which is not required is not received. After requesting to stop the transmission, if the circumstance in which the sensing data is required from the sensing apparatus occurs, the transmission may be requested again at any time.

In addition, the electronic apparatus may control at least one other electronic apparatus related to the control command based on the sensing data received as a response to the request to the sensing apparatus in operation S1050.

According to the above described embodiment, the data may be selectively collected from the sensing apparatuses and thus, the network cost may be reduced and as data which is not required is not received, the system resource overhead may be reduced.

According to the above described embodiment, the data may be selectively collected from the sensing apparatuses, and thus, the network cost may be reduced and as data which is not required is not received, the system resource overhead may be reduced.

The above described various embodiments can be implemented as a software, a hardware, or a combination thereof. According to the hardware embodiment, embodiments that are described in the disclosure may be implemented by using at least one selected from Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electrical units for performing other functions. Especially, the above described various embodiments can be implemented by the processor 110 of the electronic apparatus 100. In a software embodiment, various embodiments described in the disclosure such as a procedure and a function may be implemented as separate software modules. The software modules may respectively perform one or more functions and operations described in the embodiments.

The above-described various embodiments may be realized as a software including an instruction which may be stored in a machine-readable storage medium which may be read by a machine (e.g., a computer). The machine is an apparatus that calls the instructions stored in the storage media and which may operate according to the called instructions, and may include the electronic apparatus 100 in the embodiments.

If this instruction is executed by a processor, the processor may perform the function corresponding to the instructions by itself or by using the other elements under control of the processor. The instruction may include code generated or executed by a compiler or an interpreter. For example, as the instruction stored in the storage is executed by a processor, the controlling method of the above described electronic apparatus can be executed. For an example, as the instructions stored in the storage is executed in the processor of the apparatus (or an electronic apparatus), the methods for controlling another electronic apparatus in the electronic apparatus may be performed, the methods including receiving a voice, identifying a control command corresponding to the received voice, identifying at least one type of sensing data related to the identified control command, requesting sensing data from a sensing apparatus corresponding to the at least one type of sensing data which is identified, and controlling at least one other electronic apparatus related to the identified control command based on sensing data received in response to the request.

A machine-readable storage medium may be provided in the form of a non-transitory storage medium. Herein, the term “non-transitory” only denotes that a storage medium does not include a signal but is tangible, and does not distinguish the case where a data is semi-permanently stored in a storage medium from the case where a data is temporarily stored in a storage medium.

According to an embodiment, the method according to the above-described various embodiments may be provided as being included in a computer program product. The computer program product may be traded as a product between a seller and a consumer. The computer program product may be distributed online in the form of machine-readable storage media (e.g., compact disc ROM (CD-ROM)) or through an application store (e.g., Play Store™ and App Store™). In the case of online distribution, at least a portion of the computer program product may be at least temporarily stored or temporarily generated in a storage medium such as a memory of a server of the manufacturer, a server of the application store, or a relay server.

According to the various embodiments, the respective elements (e.g., module or program) of the elements mentioned above may include a single entity or a plurality of entities. According to the various example embodiments, at least one element or operation from among the corresponding elements mentioned above may be omitted, or at least one other element or operation may be added. Alternatively or additionally, a plurality of components (e.g., module or program) may be combined to form a single entity. In this case, the integrated entity may perform functions of at least one function of an element of each of the plurality of elements in the same manner as or in a similar manner to that performed by the corresponding element from among the plurality of elements before integration. The module, a program module, or operations executed by other elements according to variety of embodiments may be executed consecutively, in parallel, repeatedly, or heuristically, or at least some operations may be executed according to a different order, may be omitted, or the other operation may be added thereto.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method for controlling another electronic apparatus in an electronic apparatus, the method comprising:
receiving a voice;
identifying a control command corresponding to the received voice;
identifying at least one type of sensing data related to the identified control command;
requesting sensing data from a sensing apparatus corresponding to the at least one type of sensing data which is identified; and
controlling at least one other electronic apparatus related to the identified control command based on sensing data received in response to the request.

2. The method as claimed in claim 1, wherein the electronic apparatus is configured to store a matching table indicating a correlation between information on a type of sensing data that at least one sensing apparatus connected to the electronic apparatus is capable of providing and at least one control command for controlling another electronic apparatus, and
wherein the identifying comprises identifying at least one type of sensing data related to the identified control command based on the stored matching table.

3. The method as claimed in claim 2, further comprising:
based on a new sensing apparatus being connected to the electronic apparatus, requesting information on a type of sensing data that the new sensing apparatus is capable of providing, from the new sensing apparatus, and receiving information on a type of sensing data that the new sensing apparatus is capable of providing from the new sensing apparatus; and
updating the matching table based on information on a type of sensing data that the new sensing apparatus is capable of providing.

4. The method as claimed in claim 2, further comprising:
obtaining information on a type of sensing data that at least one sensing apparatus connected to the electronic apparatus is capable of providing, from an external server.

5. The method as claimed in claim 1, further comprising:
based on sensing data being continuously received from a first sensing apparatus which does not correspond to the at least one type of sensing data which is identified, requesting the first sensing apparatus to stop transmitting sensing data.

6. The method as claimed in claim 5, further comprising:
based on a control command identified based on a voice which is received after requesting the first sensing apparatus to stop transmitting sensing data, being related to a type of sensing data corresponding to the first sensing apparatus, requesting the first sensing apparatus to resume transmission of sensing data.

7. The method as claimed in claim 1, wherein the identifying a type of sensing data comprises, based on the identified control command corresponding to a sleep mode, identifying temperature and illuminance as a type of sensing data related to the identified control command, wherein the requesting comprises requesting sensing data from a temperature sensing apparatus and an illuminance sensing apparatus, and wherein the controlling comprises controlling a temperature control apparatus and a lighting apparatus for maintaining predetermined temperature and predetermined illuminance regarding the sleep mode based on sensing data received from the temperature sensing apparatus and the illuminance sensing apparatus.

8. The method as claimed in claim 7, further comprising:
based on sensing data being continuously received from an occupancy detecting sensor which does not correspond to the identified type of sensing data, requesting the occupancy detecting sensor to stop transmitting sensing data.

9. An electronic apparatus comprising:
a microphone;
a communicator;
a memory configured to store at least one computer executable instruction; and
a processor configured to execute the at least one computer executable instruction,
wherein the processor is configured to identify a control command corresponding to a voice which is received through the microphone,
identify at least one type of sensing data related to the identified control command, control the communicator to transmit a request for sensing data to a sensing apparatus corresponding to the at least one type of sensing data which is identified, and control at least one other electronic apparatus related to the identified control command based on sensing data received in response to the request through the communicator.

10. The electronic apparatus as claimed in claim 9, wherein the memory is configured to store a matching table indicating a correlation between information on a type of sensing data that at least one sensing apparatus connected to the electronic apparatus is capable of providing and at least one control command for controlling another electronic apparatus, and
wherein the processor is configured to identify at least one type of sensing data related to the identified control command based on the stored matching table.

11. The electronic apparatus as claimed in claim 10, wherein the processor is configured to, based on a new sensing apparatus being connected to the electronic apparatus, request information on a type of sensing data that the new sensing apparatus is capable of providing, from the new sensing apparatus, and receive information on a type of sensing data that the new sensing apparatus is capable of providing from the new sensing apparatus, and update the matching table based on information on a type of sensing data that the new sensing apparatus is capable of providing.

12. The electronic apparatus as claimed in claim 10, wherein the processor is configured to receive information on a type of sensing data that at least one sensing apparatus connected to the electronic apparatus is capable of providing from an external server through the communicator.

13. The electronic apparatus as claimed in claim 9, wherein the processor is configured to, based on sensing data being continuously received from a first sensing apparatus which does not correspond to the at least one type of sensing data which is identified, control the communicator to transmit a request to the first sensing apparatus to stop transmitting sensing data.

14. The electronic apparatus as claimed as claim 13, wherein the processor is configured to, based on a control command identified based on a voice which is received after requesting the first sensing apparatus to stop transmitting sensing data, being related to a type of sensing data corresponding to the first sensing apparatus, control the communicator to transmit a request to the first sensing apparatus to resume transmission of sensing data.

15. The electronic apparatus as claimed as claim 9, wherein the processor is configured to, based on the identified control command corresponding to a sleep mode, identify temperature and illuminance as a type of sensing data related to the identified control command, control the communicator to transmit a request for sensing data to a temperature sensing apparatus and an illuminance sensing apparatus, and control a temperature control apparatus and a lighting apparatus for maintaining predetermined temperature and predetermined illuminance regarding the sleep mode based on sensing data received from the temperature sensing apparatus and the illuminance sensing apparatus through the communicator.
